(19) United States
(12) Patent Application Publication
(10) Pub. No.: US 2008/0116621 A1
(43) Pub. Date: May 22, 2008

(54) Method and apparatus for thermally debinding a ceramic cellular green body

(76) Inventors: John Harold Brennan, Horseheads, NY (US); Bruce Edward Hostrander, Painted Post, NY (US); Andrew Paul Schermerhorn, Painted Post, NY (US); Michael James Vayansky, Elkland, PA (US)

Correspondence Address: CORNING INCORPORATED, SP-TI-3-1, CORNING, NY, 14831, US

(21) Appl. No.: 11/986,481

(22) Filed: Nov. 21, 2007

Related U.S. Application Data
(60) Provisional application No. 60/860,382, filed on Nov. 21, 2006.

(51) Int. Cl. C04B 33/32; F27B 9/02

(52) U.S. Cl. 264/606; 264/630; 432/128; 432/130; 432/142

(57) ABSTRACT

An apparatus for thermally debinding a cellular ceramic green body includes a duct preferably defined between a first housing and a second housing. A carrier assembly for the green body is adapted for arrangement within a channel such that the green body is positioned between a first portion of the channel and a second portion of the channel. The apparatus further includes a nozzle positioned to inject gases from the duct into a first portion of the channel and a recirculation fan positioned to draw gases out of a second portion of the channel and discharge the gases into the duct. Also described is a carrier assembly including a base support comprising a plurality of spaced stringer beams having spaces between adjacent ones; and a plurality of ring supports including openings, said ring supports mounted on, and bridging the spaces between, the stringer beams, the ring supports having a surface adapted to support the green body.

### RELATED APPLICATIONS

This application claims the benefit of U.S. Provisional Application No. 60/860,382, filed Nov. 21, 2006, entitled “Method and Apparatus for Thermally Debinding a Ceramic Cellular Green Body.”

### BACKGROUND

The invention relates generally to methods and apparatus for firing ceramic cellular bodies. More specifically, the invention relates to a method and apparatus for thermally debinding a ceramic cellular green body.

Ceramic cellular bodies, otherwise known as ceramic honeycomb substrates, are used in a variety of applications, such as exhaust gas purification applications. In exhaust gas purification applications, the ceramic cellular body may contain an array of longitudinal channels defined by intersecting porous walls, which may be bare or coated with various catalyst(s). The channels and walls are typically bounded by a surrounding skin. For particulate filtration, the channels may be divided into inlet and outlet channels and some may be plugged. Typically, the inlet channels are plugged at an outlet end of the ceramic cellular body, and the outlet channels are plugged at an inlet end of the ceramic cellular body. Exhaust gas enters the ceramic cellular body through the unplugged ends of the inlet channels, passes through the porous walls into the outlet channels, and exits through the unplugged ends of the outlet channels. When the ceramic cellular body is used as a catalyst support, it is typically not necessary to plug the channels in the ceramic cellular body. Typically, in these applications, the ceramic cellular body is made of cordierite or silicon carbide and the channels are unplugged.

In a process for making ceramic cellular bodies, a ceramic cellular green body is prepared by extruding a plasticized batch of ceramic-forming materials, and processing aids through an extrusion die. The processing aids are typically extrusion and forming aids, such as organic binders (typically methocel), plasticizers, lubricants, and pore formers. After extrusion, the green body is dried and subsequently fired at high temperature to form a ceramic cellular body having a high mechanical strength. The firing process has two main components: thermal debinding and sintering. Thermal debinding involves heating the green body, typically to a temperature less than 650° C., such that carbonaceous materials (such as methocel, pore formers and/or oils, for example) in the green body react with oxygen in the atmosphere to form volatile materials that can be released from the green body. Sintering also involves heating the green body, but to a much higher temperature than used in the thermal debinding process. Typically, this temperature is in a range from 1000° C. to 1600° C., or higher. During sintering, any remaining carbonaceous materials in the green body may also react with oxygen, and the resulting volatile materials may be released.

Large temperature differentials between the interior and exterior of the green body during thermal debinding can be a major cause of crack formation in the fired ceramic cellular bodies. Therefore, it is desirable to minimize the temperature differential between the interior and exterior of the green body during the thermal debinding step.

### SUMMARY

In one aspect, the invention relates to an apparatus for thermally debinding a ceramic cellular green body which comprises a duct defined between a first housing and a second housing, a carrier for the green body arranged within a channel defined by the first housing such that the green body is positioned between a first portion of the channel and a second portion of the channel, a nozzle positioned to inject gases from the duct into the first portion of the channel, and a recirculation fan positioned to draw gases from the second portion of the channel and discharge the gases into the duct.

In another aspect, the invention relates to a method of thermally debinding a ceramic cellular green body which comprises disposing the green body in a channel, receiving gases from a duct and discharging the gases into a first portion of the channel and allowing the gases in the first portion of the channel to flow into and around the green body into a second portion of the channel, and drawing the gases out of the second portion of the channel and discharging the gases into the duct.

In yet another aspect, the invention relates to an apparatus for supporting a ceramic cellular green body in a kiln, such as a tunnel kiln, which comprises a base support having spaces for flow of gases, and a ring support mounted on the base support. The ring support may have an annular body and an annular surface upon which the green body rests. The outer diameter of the annular body is selected to be the same as or slightly smaller than an outer dimension of the green body.

Other features and advantages of the invention will be apparent from the following description and the appended claims.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1 is a vertical cross-section of a debinding unit.

FIG. 2 is a block diagram of a tunnel kiln including a plurality of the debinding units of FIG. 1.

FIG. 3A is a side view of carrier assembly for supporting ceramic cellular green bodies in the debinding unit of FIG. 1.

FIG. 3B is a top view of the base support of the carrier assembly of FIG. 3A.

FIG. 3C is a cross-sectional view of the support ring of the carrier assembly of FIG. 3A.

FIG. 3D is a partial top view of the support ring mounted on the spaced stringer beams of FIG. 3A.

FIG. 3E is a partial cross-sectional side view of the support ring mounted on the spaced stringer beams of FIG. 3A.

FIG. 4 is a top view of the support ring mounted on the spaced stringer beams of and illustrating a high density packing arrangement achievable with the invention.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

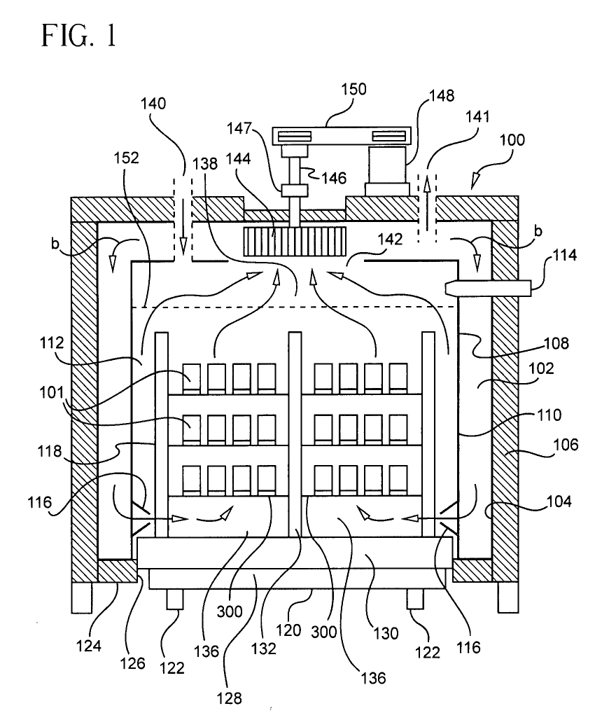

FIG. 1 depicts a vertical cross-section of a debinding unit 100 for thermally debinding ceramic cellular green bodies 101. As will be illustrated later, a tunnel kiln may include one or more debinding units 100 for continuous firing of ceramic cellular bodies. The debinding unit 100 provides a homogeneous atmosphere around the green bodies 101 during thermal debinding of the green bodies 101, particularly when fresh gases are continuously or periodically injected into the atmosphere. One reason for injecting fresh gases into the kiln atmosphere may be to reduce the oxygen content of the atmosphere, or to reduce the concentration of volatile organic compounds (VOCs) in the atmosphere. Providing a homogeneous atmosphere around the green bodies 101 during thermal debinding may have the effect of promoting a uniform temperature distribution around the green bodies 101, which may, in turn, reduce induced thermal stresses in the green bodies 101 that may otherwise lead to crack formation in the green bodies 101. The debinding unit 100 induces axial flow of the homogeneous atmosphere through the interior of the green bodies 101. This induced axial flow may have the effect of reducing the temperature differential between the interior and the exterior of the green bodies 101, as well as facilitating removal of volatile materials from the interior of the green bodies 101.

In FIG. 1, the debinding unit 100 includes a duct 102 defined by an inner surface 104 of an outer housing 106 and an outer surface 108 of an inner housing 110. The outer portion of the outer housing 106 may be made of an insulating material, such as refractory material or other insulating material suitable for making furnace chambers. The inner surface 104 may be lined with stainless steel or other corrosion-resistant, highly-conductive metal, for example. The inner housing 110 may be made of stainless steel or other corrosion-resistant, highly-conductive metal as well, for example. The inner housing 110 defines a longitudinal channel 112 for receiving within, and for passage of the green bodies 101 therethrough. The inner housing 110 may be perforated to allow exchange of gases between the channel 112 and the duct 102. A burner 114 is inserted through the inner housing 110, and possibly the outer housing 106, to deliver heated flow to the channel 112, as desired. Although only one burner 114 is shown, the debinding unit 100 may include additional burners for delivering heated flow to the channel 112, as required for the particular ceramic being debindered. Nozzles 116 are inserted through the inner housing 110 or formed in the wall of the inner housing 110 to deliver gases into the channel 112. For example, where the inner housing 110 is made of a metal, the nozzles 116 could be sheet metal nozzles.

The green bodies 101 are mounted on, and move along with a moveable kiln car 118. Typically, several kiln cars 118 are used to convey stacks of green bodies 101 through the channel 112 in a continuous or semi-continuous manner. The kiln car 118 may be conveyed through the channel 112 using a suitable conveyance mechanism, such as a rail or belt conveyor or other motive element. In the example illustrated in FIG. 1, the kiln car 118 includes a deck 120 supported on wheels 122. A base portion 124 of the kiln includes an opening 126 for receiving the deck 120 of the kiln car 118. The deck 120 may be made of one or more layers of material. For example, the deck 120 may include a base layer 128 made of a durable material, such as a metal (e.g., steel), and a top layer 130 made of an insulating material, such as a high-temperature ceramic fiber insulation. Vertical posts 132 project upwardly from the deck 120 of the kiln car 118. Carriers 300 for supporting the green bodies 101 extend between the vertical posts 132, and are coupled to, and mounted upon, the vertical posts 132. For example, the vertical posts 132 may include lugs on which the carriers 300 may be mounted. A load space 136 is provided in the channel 112 below the stack of carriers 300 and green bodies 101. A plenum 138 is provided in the channel 112 above the stack of carriers 300 and mounted green bodies 101. The nozzles 116 are positioned to receive gases from the duct 102 and deliver the gases to the load space 136. The burner 114 is positioned to receive fuel from an external source and deliver heat to the plenum 138. Ports 140, 141 may extend through the inner and outer housings 110, 106 into the channel 112 to allow direct injection of additional gases into the channel 112, i.e., traverse the duct 102, and/or to allow direct removal of exhaust gases from the channel 112. The ports 140, 141 may be positioned at the top of the debinding unit 100 as shown, or at the sides or bottom of the debinding unit 100.

A high volume recirculation fan 144 is mounted above an opening 142 at the top of the inner housing 110 and at the top of the channel 112. For illustration purposes, the recirculation fan 144 is coupled to a shaft 146, which is supported for rotation on bearings 147. The shaft 146 is in turn coupled to a motor 148 through a system of pulleys 150. In practice, any suitable system for operating the recirculation fan 144 may be used. The high volume recirculation fan 144 draws gases from the plenum 138 and discharges the gases into the duct 102 as illustrated by arrows labeled “b.” A perforated plate 152 is provided in the plenum 138, above the stack of green bodies 101, to allow even drawing of the gases in the plenum 138 by the recirculation fan 144. The perforated plate 152 assists in a more uniform distribution of gases across the plenum 138. During debinding, gases in the duct 102 are injected into the load space 136 through the nozzles 116. The gases are drawn upwardly from the load space 136, through and around the stack of green bodies 101, into the plenum 138, where they mix with the gases in the plenum 138, which may include burner flow and injected gases, such as low oxygen content (or inert) gases. The gases in the plenum 138 are then drawn into the inlet of the recirculation fan 144, which pressurizes the gases and returns them to the duct 102, causing them to be re-circulated where they are again drawn into the load space 136 through the nozzles 116.

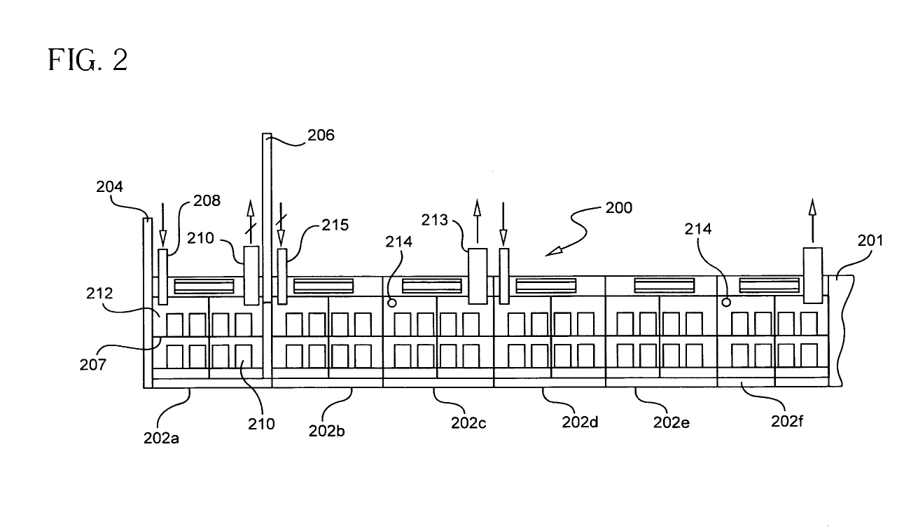

FIG. 2 is a simplified diagram of a tunnel kiln 200 including an array of debinding units 202a-202f, as described above. The number of debinding units in the tunnel kiln 200 is arbitrary in this figure. Typically, the number of debinding units needed would be determined by the heating rates, the temperature setpoint, and the amount and type of carbonaceous materials in the green bodies. Typically, thermal debinding occurs at temperatures ranging from room temperature to about 650° C., with temperature increasing from the first debinding unit 202a to the last debinding unit 202f. The debinding units 202a-202f are followed by a higher temperature sintering section 201, and then a cooling section (not shown). Sintering takes place at temperatures in excess of 650° C., typically in a range from 1000° C. to 1600° C.

The debinding unit 202a is provided with an outside door 204 and an inside door 206 and forms a vestibule section of the tunnel kiln 200. To load the tunnel kiln 200 with fresh green bodies, the inside door 206 is closed and the outside door 204 is opened. A kiln car 207 carrying green bodies 210 is then allowed to enter the kiln channel 212 of the debinding unit 202a. The outside door 204 may then be closed, and the channel 212 of the debinding unit 202a may be purged with the same oxygen level preheated gas as in debinding unit 202b prior to opening the inside door 206 and allowing the kiln car 207 to move into the debinding unit 202b. As shown, the debinding unit 202a is provided with inlet and outlet ports 208, 210 for injecting and removing gases from the channel 212, for example, for the purposes of purging the channel 212. The gases may be, for example, any VOC cleaned gas, such as air, N₂, helium, Argon or other inert gas, or even gases re-circulated back from the VOC abatement process (a thermal oxidizer) provided the gas temperature is at or below the set point temperature. In particular, any recirculated gas should be scrubbed of any corrosive acids such as fluorine or chlorine.

The debinding units 202b, 202c form a temperature/atmosphere preconditioning section of the tunnel kiln 200. After moving the kiln car 207 from the debinding unit 202a into the debinding unit 202b, the inside door 206 of the debinding unit 202a can be closed, and the debinding units 202b, 202c can be purged by injecting gases into the debinding unit 202b through the inlet port 215 and removing gases from the debinding unit 202c through the outlet port 213. The debinding units 202b, 202c are purged so that the atmosphere, e.g., oxygen level, in these units is close to the atmosphere, e.g., oxygen level, in the adjacent unit 202d. The green bodies are also heated to an initial temperature in the debinding units 202b, 202c. Thermal debinding of the green bodies continues in the debinding units 202d-202f. After thermal debinding, the green bodies are moved into the sintering section 201 of the tunnel kiln 200. After sintering, the green bodies are cooled down.

As the green bodies are heated in the debinding units 202a-202f, volatile organic compounds (VOCs) are released into the kiln atmosphere. It is important to maintain the VOC level at a safe limit to avoid a possible explosion. In the illustration, lower flammability limit (LFL) detectors 214 are positioned in the debinding units 202c, 202f to detect the VOC level. The output of the LFL detectors 214 can be used to determine when to inject low oxygen (or inert) gases into the kiln atmosphere in order to control the VOC level. The multiple debinding units 202a-202f allow the amount of low oxygen content (or inert) gases injected into the kiln atmosphere to be tailored to the VOC level along the tunnel kiln 200.

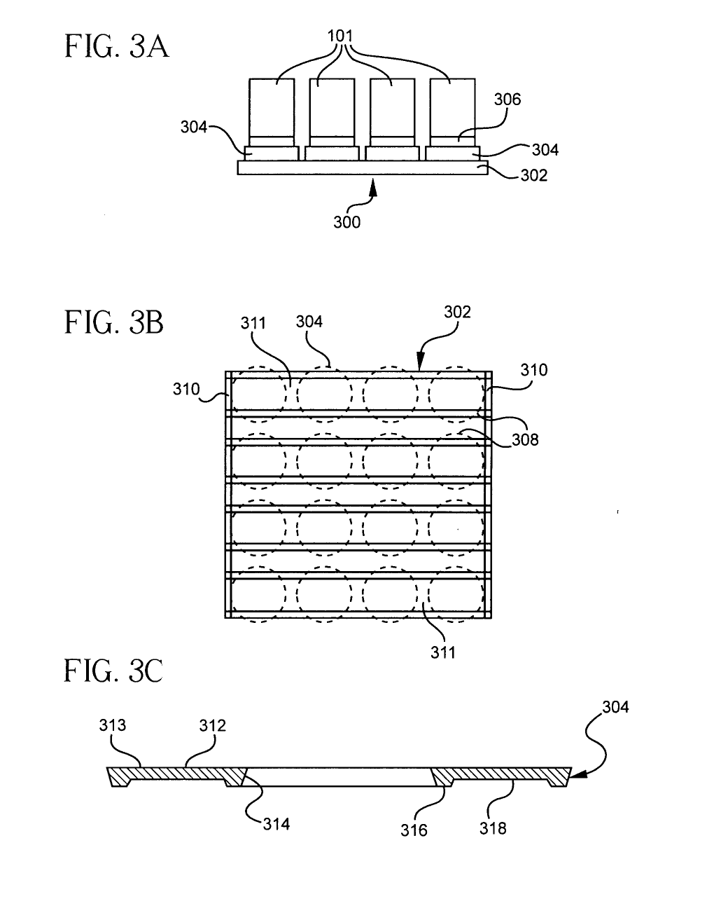

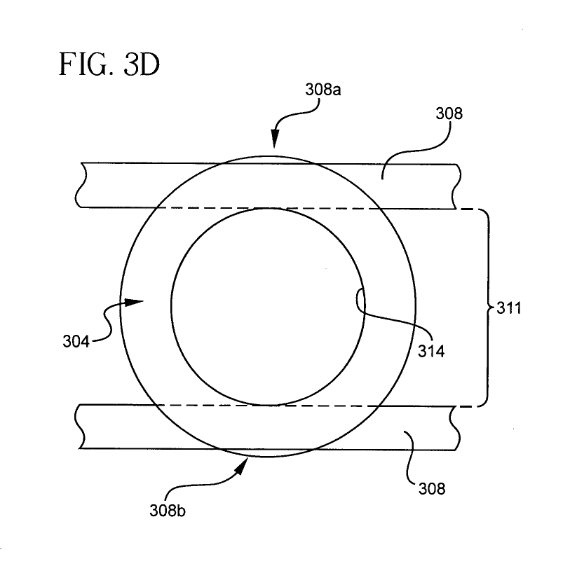

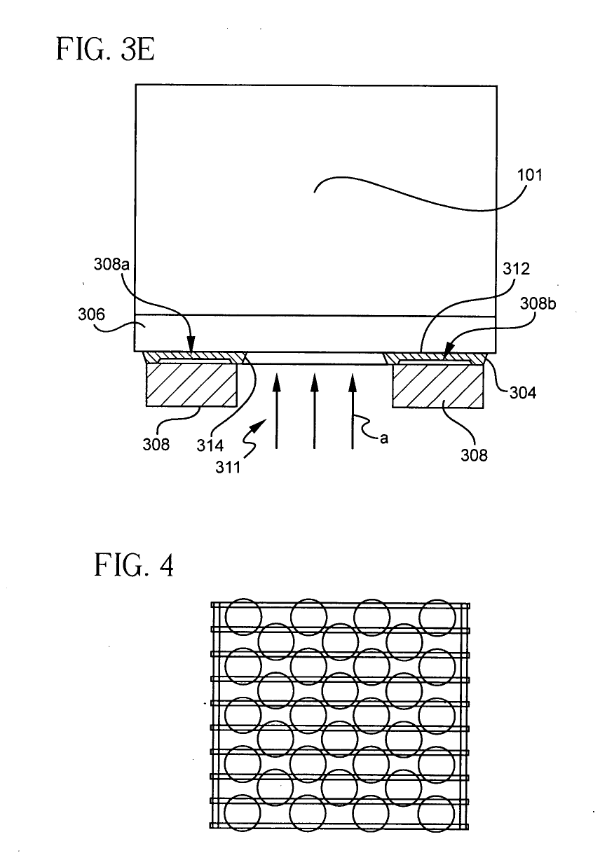

FIG. 3A shows in greater detail the carrier assembly 300 used in supporting the green bodies 101 on the kiln car (118 in FIG. 1). The carrier assembly 300 includes a base support 302 and a plurality of ring supports 304 mounted on the base support 302. Also shown are cookies or sacrificial disks 306 between the ring supports 304 and the green bodies 101. The cookies 306 may be made of the same material as the green bodies 101 and help protect the bottom ends of the green bodies 101 from warping and contamination from the material of the ring supports 304.

FIG. 3B shows one example of the base support 302. The base support 302 may include an array of stringer beams 308. The stringer beams 308 are spaced apart and arranged in generally parallel relation to each other, and mounted on cross beams 310, such as at their ends. The stringer beams 308 and cross beams 310 may be made of any suitable high temperature material for kiln furniture, such as silicon carbide. The spaces 311 between the stringer beams 308 allow free flow of gas (indicated by arrows “a”) in the load space (136 in FIG. 1) to readily reach the bottom ends of the green bodies (101 in FIG. 3A-3E) mounted on the ring supports 304. FIG. 3B shows one possible arrangement of the ring supports 304 on the base support 302. In particular, the ring supports 304 rest on the stringer beams 308 at two locations 308a, 308b thereby leaving the space 311 between the stringer beams vertically aligned with the opening in the ring support 304 (see FIG. 3D-3E). The ring supports 304 may also be staggered on the stringer beams 308 to achieve a different arrangement and higher packing density of the green bodies. The base support 302 may also have alternate configurations. For example, a perforated or slotted plates may also be used as the base support 302 wherein the ring supports rest and are mounted on the base supports.

FIG. 3C shows a cross-section of the ring support 304. The ring support 304 may include an annular body 312 having a planar surface 313, such as an annular surface, for supporting the cookie and green body mounted thereon. An inner dimension of the opening 314 in the ring support 304 of the annular body 312 is made large enough to allow substantial exposure of the bottom end of the green body to the gases in the load space (136 in FIG. 1). In other words, the inner dimension of the opening 314 of the body 312 is selected to substantially match the outer diameter of the green body, but of course being smaller than the outer diameters such that the body is supported. In particular, a minimum amount of overlap is desired. The underside 316 of the annular body 312 may include an undercut 318, which has the effect of minimizing the contact area between the ring support 304 and the base support (302 in FIG. 3A) when the ring support 304 is mounted on the base support as shown in FIG. 3A. The ring support 304 may be made of a high temperature ceramic material, such as silicon carbide, alumina, mullite, and zirconia or other like refractory materials.

Other modifications are possible to the examples described above. For example, referring to FIG. 1, a fan or other suitable device may be used to assist in pushing gases in the load space 136 into and through the arrangement of green bodies 101. The fan may be used in addition to or in lieu of the nozzles 116. In the latter case, the fan may draw gases from the duct 102 and discharge the gases into the load space 136 with sufficient pressure to induce axial flow through the green bodies 101. Suitable ducting may also be used to channel the gases in the load space 136 into the green bodies 101.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for thermally debinding a cellular ceramic green body, comprising:
a channel receiving a carrier assembly upon which a plurality of ceramic green bodies are mounted, the channel include a first portion and second portion,
a duct connected to the channel;
a recirculation fan positioned to draw gases out of the second portion of the channel and discharge the gases into the duct; and
a nozzle positioned to inject gases from the duct into the first portion of the channel.

2. An apparatus of claim 1 wherein the duct is formed in a space between a first housing and a second housing.

3. The apparatus of claim 1 wherein the carrier assembly includes a base support including spaces through which gases can flow vertically from the first portion into an interior of the green body.

4. The apparatus of claim 3, wherein the base support includes a plurality of stringer beams and a plurality of ring supports mount on the stringer beams, wherein the green bodies rest upon the ring supports.

5. The apparatus of claim 3, wherein the carrier assembly comprises ring supports having annular bodies and annular surfaces for supporting the green bodies.

6. The apparatus of claim 3, further including ring support mounted on the base support wherein an underside of the ring support comprises an undercut which minimizes a contact area between the ring support and the base support when the ring support is mounted on the base support.

7. The apparatus of claim 1, further comprising a gas injection port traversing the duct for injecting gases into the channel.

8. The apparatus of claim 1, further comprising a gas extraction port into the duct for removing gases from the channel.

9. The apparatus of claim 1, wherein the carrier assembly is coupled to a kiln car which is movable through the channel.

10. The apparatus of claim 1, further comprising a burner positioned to provide heated flow into the channel.

11. The apparatus of claim 1, wherein the first housing is perforated.

12. A method of thermally debinding a ceramic cellular green body, comprising:
disposing the green body in a channel;
receiving gases from a duct and discharging the gases into a first portion of the channel and allowing the gases to flow into and around the green body into a second portion of the channel; and
drawing the gases out of the second portion of the channel and discharging the gases into the duct.

13. The method of claim 12, wherein the gases are drawn out of the second portion of the channel and discharged into the duct using a recirculation fan.

14. The method of claim 12, further comprising heating the green body to a temperature sufficient to facilitate oxidation of carbonaceous materials in the green body.

15. An apparatus for supporting a ceramic cellular green body in a kiln, comprising:
a base support comprising a plurality of spaced stringer beams having spaces between adjacent ones of the stringer beams allowing flow of gases; and
a plurality of ring supports including openings, said ring supports mounted on, and bridging the spaces between, the stringer beams, the ring supports having a surface adapted to support the green body.

16. The apparatus of claim 15 wherein the ring support includes an annular body and an annular surface for mounting of the green body.

17. The apparatus of claim 15 wherein an outer dimension of the annular body is selected to the same or smaller than an outer dimension of the green body.

18. The apparatus of claim 15, wherein the base support is coupled to a moving kiln car.

19. The apparatus of claim 15 wherein ring supports extend between adjacent spaced stringer beams.

20. The apparatus of claim 15 wherein the base support includes an array of stringer beams and cross beams and stringer beams extend between and mount on the cross beams.
